(19) United States
(12) Patent Application Publication
(10) Pub. No.: US 2013/0187862 A1
(43) Pub. Date: Jul. 25, 2013

(54) SYSTEMS AND METHODS FOR OPERATION ACTIVATION

(71) Applicants: Cheng-Shiun Jan, Taoyuan County (TW); Chun-Hsiang Huang, Taoyuan County (TW)

(72) Inventors: Cheng-Shiun Jan, Taoyuan County (TW); Chun-Hsiang Huang, Taoyuan County (TW)

(21) Appl. No.: 13/353,991

(22) Filed: Jan. 19, 2012

(51) Int. Cl. G06F 3/041

(52) U.S. Cl. 345/173

(57) ABSTRACT

Methods and systems for operation activation are provided. An image is displayed on a touch-sensitive display unit. At least one object in the image is recognized using an object recognition algorithm, and at least one indicator for the at least one object is displayed on the touch-sensitive display unit. At least one operation is retrieved according to the at least one object. An instruction with respect to the at least one indicator is received via an input device, such as the touch-sensitive display unit, and the at least one operation regarding the at least one object is automatically performed according to the instruction.

### BACKGROUND OF THE INVENTION

1. Field of the Invention

The disclosure relates generally to methods and systems for operation activation, and, more particularly to methods and systems that automatically retrieve and perform at least one operation for at least one object which is recognized in an image displayed on the touch-sensitive display unit.

2. Description of the Related Art

Recently, portable devices, such as handheld devices, have become more and more technically advanced and multifunctional. For example, a handheld device may have telecommunications capabilities, e-mail message capabilities, an advanced address book management system, a media playback system, and various other functions. Due to increased convenience and functions of the devices, these devices have become necessities of life.

Currently, a handheld device may be equipped with a touch-sensitive display unit. Users can directly perform operations, such as application operations and data input via the touch-sensitive display unit. Generally, when a user wants to perform an operation on the handheld device, the user must manually activate an application/function of the mobile device, and set related information, such as email addresses or phone numbers of receivers via the touch-sensitive display unit. The activation process for the operation is inconvenient and time-consuming for users.

Generally, a plurality of applications can be installed in a handheld device to provide various functions. It is understood that, respective applications may have various requirements. For example, the number of users involved in an application may be limited. In a case, when one user (receiver) is specified, an email function or a dial-up function can be provided to the specified user. In another case, when several users are specified, an ad-hoc network connection function can be provided to the specified users. That is, when the function is performed, an ad-hoc network can be established for the specified users. Conventionally, users must know the requirements of the respective applications, and manually perform the selection and performance of the applications, thus requiring more complex operations and actions to be performed by the users. Currently, however, no automatic and efficient mechanism is provided for operation activation, thus users are less apt to use the functions of handheld devices.

### BRIEF SUMMARY OF THE INVENTION

Methods and systems for operation activation are provided.

In an embodiment of a method for operation activation, an image is displayed on a touch-sensitive display unit. At least one object in the image is recognized using an object recognition algorithm, and at least one indicator for the at least one object is displayed on the touch-sensitive display unit. At least one operation is retrieved according to the at least one object. An instruction with respect to the at least one indicator is received via the touch-sensitive display unit, and the at least one operation regarding the at least one object is automatically performed according to the instruction.

An embodiment of a system for operation activation includes a storage unit, a touch-sensitive display unit, and a processing unit. The storage unit comprises a plurality of operations for a plurality of objects. The touch-sensitive display unit displays an image. The processing unit recognizes at least one object in the image using an object recognition algorithm, and displays at least one indicator for the at least one object on the touch-sensitive display unit. The processing unit retrieves at least one operation from the storage unit according to the at least one object. The processing unit receives an instruction with respect to the at least one indicator via the touch-sensitive display unit, and automatically performs the at least one operation regarding the at least one object according to the instruction.

In some embodiments, the at least one indicator is displayed as an icon besides or near the at least one object, or as an image covers part or all of the at least one object.

In some embodiments, at least one specific indicator within the at least one indicator for the at least one object is further selected, and the at least one operation is retrieved according to the selected at least one specific indicator.

In some embodiments, the at least one operation is retrieved further according to the type or the number of the at least one object.

In some embodiments, the at least one operation is displayed on the touch-sensitive display unit. In some embodiments, the instruction can comprise contacts and movements involving the at least one indicator and a specific operation of the at least one operation on the touch-sensitive display unit.

Methods for operation activation may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of a system for operation activation of the invention;

FIG. 2 is a flowchart of an embodiment of a method for operation activation of the invention;

FIG. 3A is a schematic diagram illustrating an embodiment of an example of an image displayed in the touch-sensitive display unit;

FIG. 3B is a schematic diagram illustrating an embodiment of an example of an indicator for an object in the image of FIG. 3A;

FIG. 4 is a flowchart of another embodiment of a method for operation activation of the invention;

FIG. 5 is a schematic diagram illustrating an embodiment of an example of operation icons displayed in the touch-sensitive display unit; and

FIG. 6 is a schematic diagram illustrating another embodiment of an example of operation icons displayed in the touch-sensitive display unit.

### DETAILED DESCRIPTION OF THE INVENTION

Methods and systems for operation activation are provided.

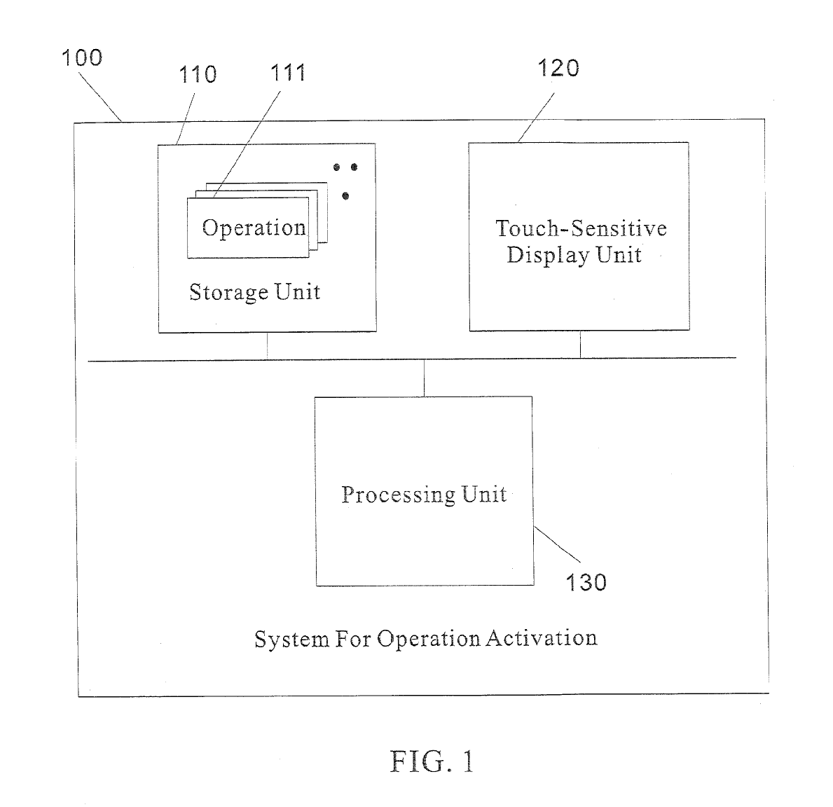

FIG. 1 is a schematic diagram illustrating an embodiment of a system for operation activation of the invention. The system for operation activation can be used in an electronic device, such as a PDA (Personal Digital Assistant), a smart phone, a mobile phone, an MID (Mobile Internet Device, MID), a laptop computer, a car computer, a digital camera, a multi-media player, a game device, or any other type of mobile computational device, however, it is to be understood that the invention is not limited thereto.

The system for operation activation 100 comprises a storage unit 110, a touch-sensitive display unit 120, and a processing unit 130. The storage unit 110 can be used to store related data, such as calendars, files, web pages, images, and/or interfaces. It is noted that, the storage unit 110 can include a database recoding relationships between a plurality of operations 111, such as applications/functions and a plurality of objects, such as faces or bodies of users, products, and others. It is noted that, in some embodiments, the database can further record semantics or properties of objects. The semantics or properties can be used to recognize the type of the objects. It is understood that, each operation can correspond to a specific number of objects. In one example, an operation can be performed for only one object. In another example, an operation can be performed for a plurality of objects. It is understood that, in some embodiments, the operations may comprise an email function, a permission management function, a data retrieval function, an ad hoc network connection function, and others. It is understood that, the above operations are examples of the present application, and the present invention is not limited thereto. In some embodiments, the system for operation activation 100 may further comprise an image capturing unit (not shown), used for capturing images, which can be stored in the storage unit 110. The touch-sensitive display unit 120 is a screen integrated with a touch-sensitive device (not shown). The touch-sensitive device has a touch-sensitive surface comprising sensors in at least one dimension to detect contact and movement of an object (input tool), such as a pen/stylus or finger near or on the touch-sensitive surface. The touch-sensitive display unit 120 can display the data provided by the storage unit 110. The processing unit 130 can perform the method for operation activation of the present invention, which will be discussed further in the following paragraphs.

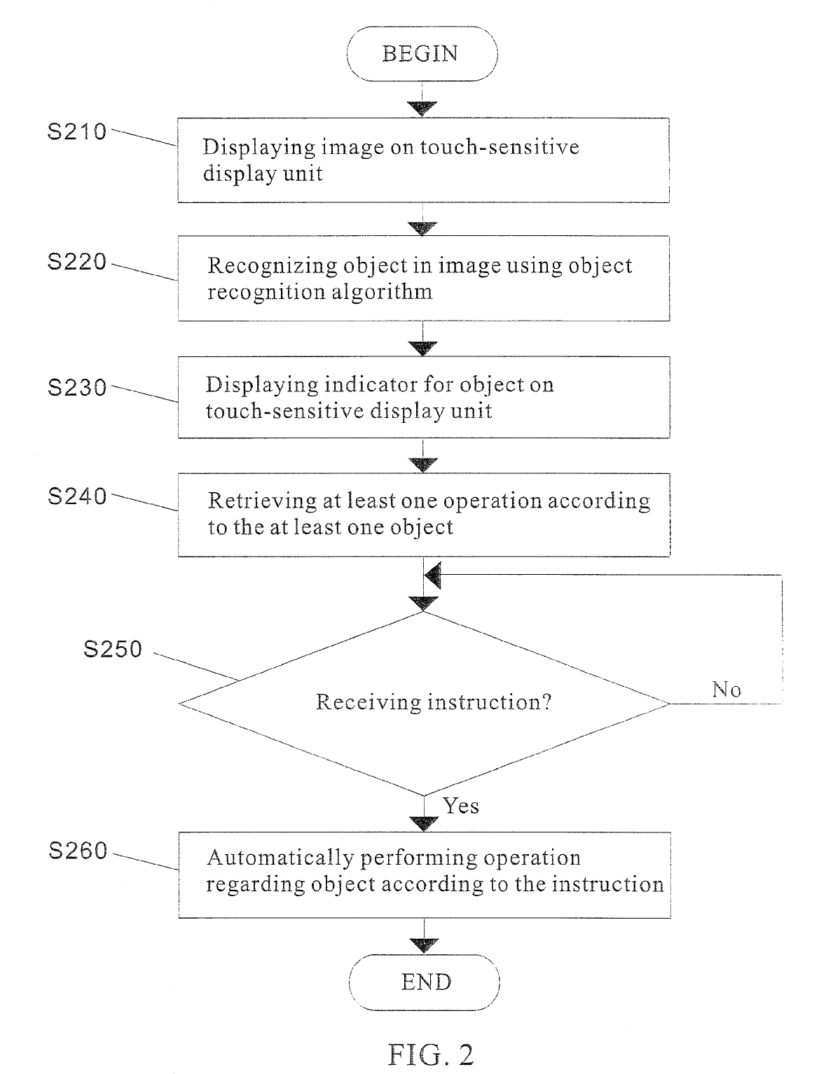

FIG. 2 is a flowchart of an embodiment of a method for operation activation of the invention. The method for operation activation can be used for an electronic device, such as a PDA, a smart phone, a mobile phone, an MID, a laptop computer, a car computer, a digital camera, a multi-media player or a game device.

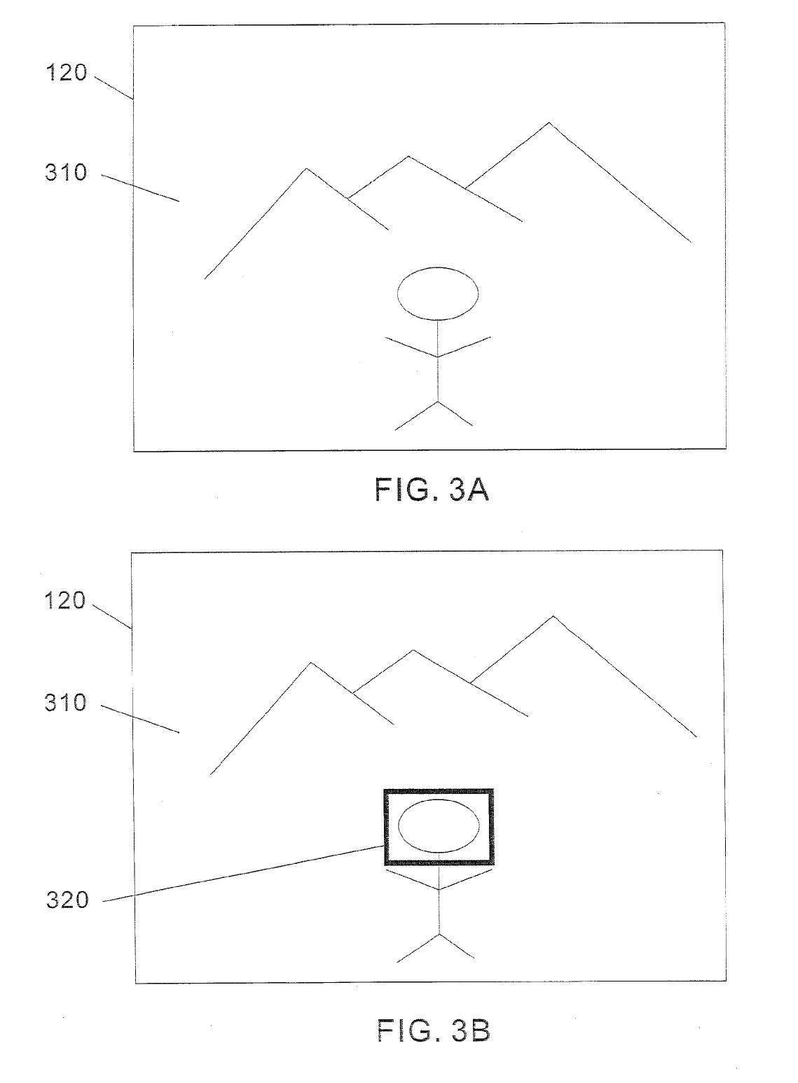

In step S210, an image is displayed on a touch-sensitive display unit 120. It is understood that, in some embodiments, the image can be obtained from the storage unit 110. In some embodiments, the image can be real time captured via an image capturing unit of the electronic device. In step S220, an object recognition algorithm is applied to the image to recognize/detect at least one object in the image, and in step S230, at least one indicator for the at least one object is displayed on the touch-sensitive display unit 120. It is understood that, in some embodiments, the at least one indicator can be displayed as an icon besides or near the at least one object. In some embodiments, the at least one indicator can be displayed as an image covers part or all of the at least one object. For example, an image 310 can be displayed on the touch-sensitive display unit 120, as shown in FIG. 3A. After the object recognition algorithm is applied to the image 310, an object, such as a face of a user is detected, and an indicator 320 is displayed to cover the detected object, as shown in FIG. 3B. It is noted that, the above display manners of the indicator are examples of the present application, and the present invention is not limited thereto. The display manner of the indicator can be various. Then, in step S240, at least one operation is retrieved according to the at least one object. It is understood that, in some embodiments, at least one specific indicator within the at least one indicator for the at least one object can be further selected using an input tool, such as a finger or a stylus via the touch-sensitive display unit 120, and the at least one operation is retrieved according to the selected at least one specific indicator. As described, each operation can correspond to a specific number of objects. In some embodiments, when at least two indicators are selected, the intersection of the operations corresponding to the selected at least two indicators is retrieved. Further, in some embodiments, the at least one operation can be retrieved further according to the type and/or the number of the at least one object. As described, the type of the object may be a face or body of users, a product, and others. In some embodiments, the type of the object can be recognized according to the semantics or properties of the object. In step S250, it is determined whether an instruction for the at least one indicator is received. It is understood that, in some embodiments, the instruction may comprise touch events and/or mouse events, such as clicking/tapping, double-clicking, dragging and dropping, and others for the at least one indicator via an input device, such as the touch-sensitive display unit 120. If no instruction is received (No in step S250), the procedure remains at step S250. If an instruction is received (Yes in step S250), in step S260, the at least one operation regarding the at least one object is automatically performed.

In an embodiment, when a user double-clicks an indicator corresponding to a face detected in the image, an email function is automatically activated to compose an email message for a specific user with the face. It is understood that, in some embodiments, the detected face can be compared with a contact database to know the specific user and related information, such as an email address of the specific user. The related information of the specific user can be automatically brought to the email function. In another embodiment, when a user draws a circle to cover two indicators corresponding to two faces detected in the image, an ad-hoc network connection function is automatically activated to set up an ad-hoc network with the two specific users with the faces. Similarly, the detected face can be compared with a contact database to know the specific user and related information, such as a network address of a mobile device of the specific user. The related information of the specific user can be automatically brought to the ad-hoc network connection function.

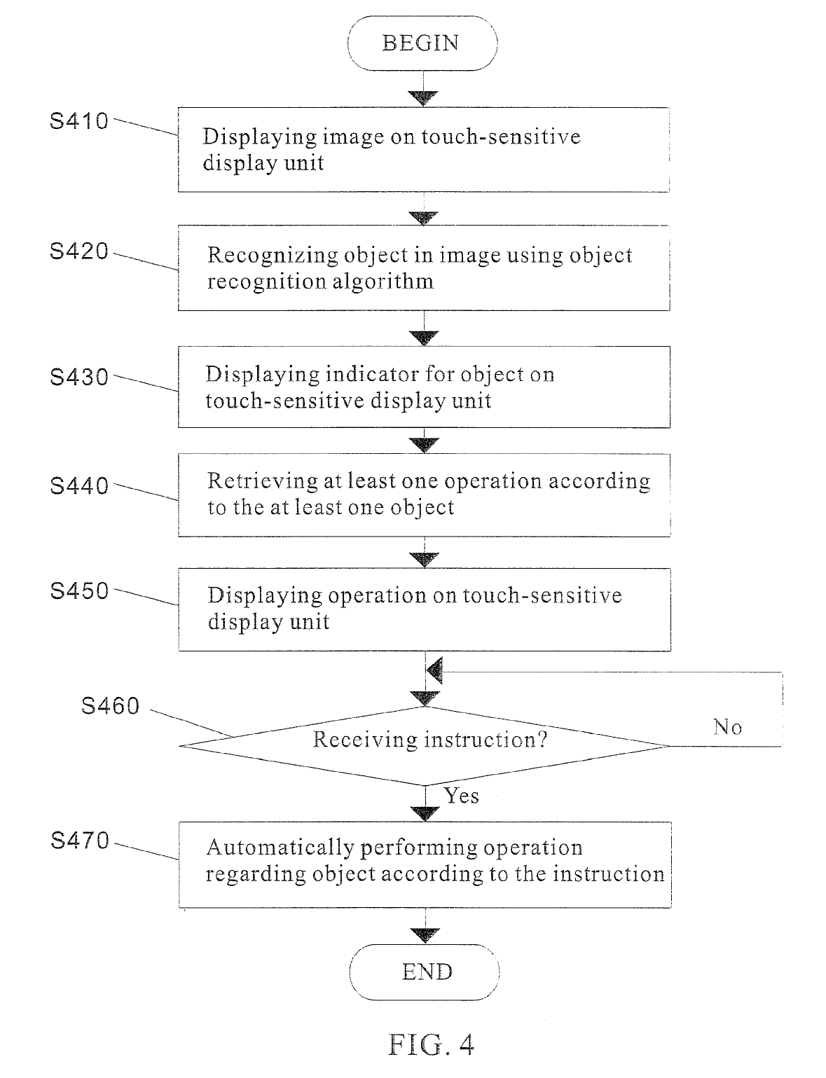

FIG. 4 is a flowchart of another embodiment of a method for operation activation of the invention. The method for operation activation can be used for an electronic device, such as a PDA, a smart phone, a mobile phone, an MID, a laptop computer, a car computer, a digital camera, a multi-media player or a game device.

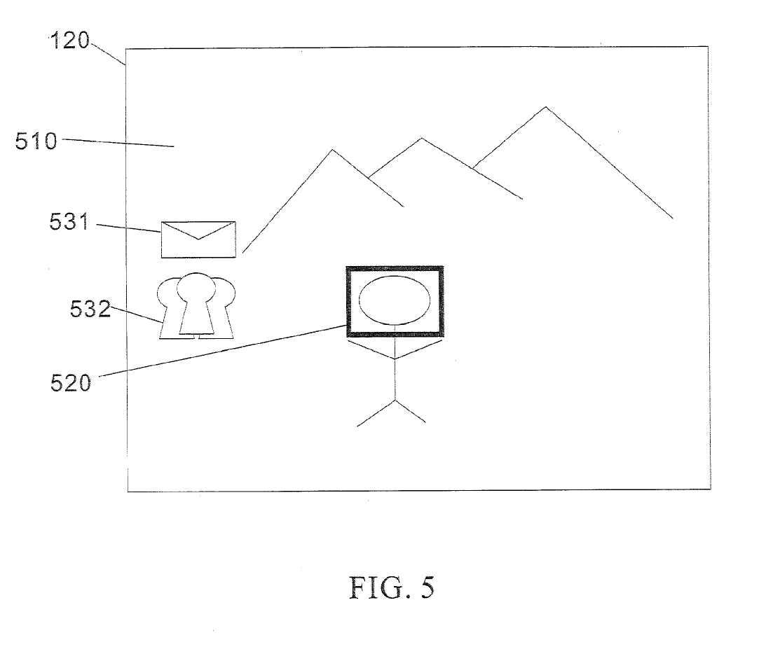

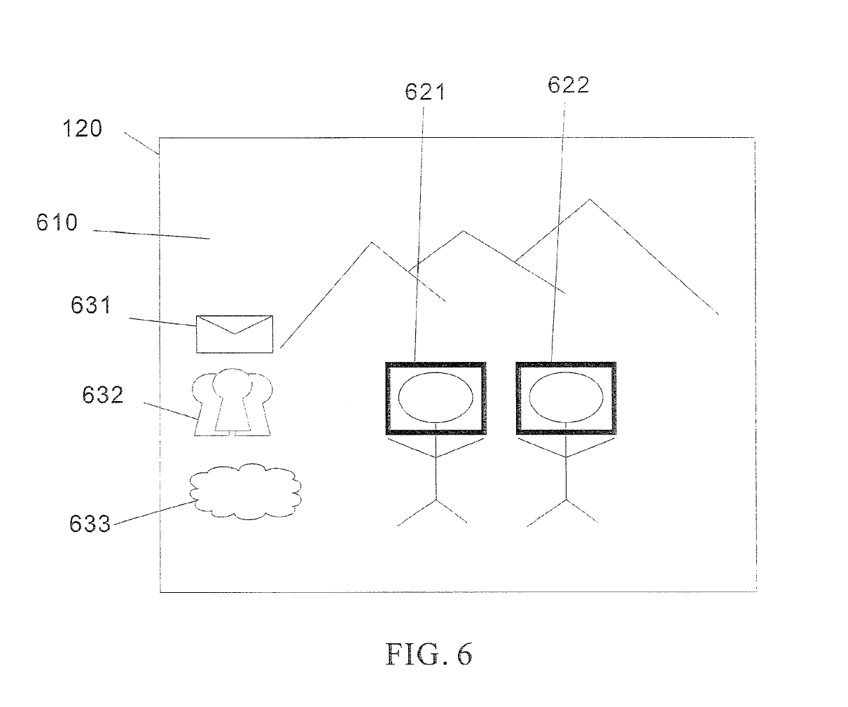

In step S410, an image is displayed on a touch-sensitive display unit 120. Similarly, in some embodiments, the image can be obtained from the storage unit 110. In some embodiments, the image can be real time captured via an image capturing unit of the electronic device. In step S420, an object recognition algorithm is applied to the image to recognize/detect at least one object in the image, and in step S430, at least one indicator for the at least one object is displayed on the touch-sensitive display unit 120. Similarly, in some embodiments, the at least one indicator can be displayed as an icon besides or near the at least one object. In some embodiments, the at least one indicator can be displayed as an image covers part or all of the at least one object. It is noted that, the above display manners of the indicator are examples of the present application, and the present invention is not limited thereto. The display manner of the indicator can be various. Then, in step S440, at least one operation is retrieved according to the at least one object. It is understood that, in some embodiments, at least one specific indicator within the at least one indicator for the at least one object can be further selected using an input tool, such as a finger or a stylus via the touch-sensitive display unit 120, and the at least one operation is retrieved according to the selected at least one specific indicator. As described, each operation can correspond to a specific number of objects. In some embodiments, when at least two indicators are selected, the intersection of the operations corresponding to the selected at least two indicators is retrieved. Further, in some embodiments, the at least one operation can be retrieved further according to the type and/or the number of the at least one object. As described, the type of the object may be a face or body of users, a product, and others. In some embodiments, the type of the object can be recognized according to the semantics or properties of the object. After the at least one operation is retrieved, in step S450, the at least one operation is displayed on the touch-sensitive display unit 120. For example, an image 510 can be displayed on the touch-sensitive display unit 120, as shown in FIG. 5. After the object recognition algorithm is applied to the image 510, an object, such as a face of a user is detected, and an indicator 520 is displayed to cover the detected object. An email function and an instant message function can be retrieved according to the type and number of the detected face, such that an icon 531 corresponding to the email function and an icon 532 corresponding to the instant message function can be displayed on the touch-sensitive display unit 120, as shown in FIG. 5. In another example, an image 610 can be displayed on the touch-sensitive display unit 120, as shown in FIG. 6. After the object recognition algorithm is applied to the image 610, two objects, such as faces of users are detected, and two indicators 621 and 622 are displayed to respectively cover the detected objects. In this example, an email function, an instant message function, and an ad-hoc network connection function can be retrieved according to the type and number of the detected faces, such that an icon 631 corresponding to the email function, an icon 632 corresponding to the instant message function, and an icon 633 corresponding to the ad-hoc network connection function can be displayed on the touch-sensitive display unit 120, as shown in FIG. 6. In step S460, it is determined whether an instruction for the at least one indicator is received. It is understood that, in some embodiments, the instruction may comprise touch events and/or mouse events, such as clicking/tapping, double-clicking, dragging and dropping, and others for the at least one indicator via an input device, such as the touch-sensitive display unit 120. In some embodiments, the instruction can comprise contacts and movements involving the at least one indicator and a specific operation of the at least one operation displayed on the touch-sensitive display unit 120. If no instruction is received (No in step S460), the procedure remains at step S460. If an instruction is received (Yes in step S460), in step S470, the involved operation regarding the involved object is automatically performed according to the instruction.

In an embodiment, when a user drags an indicator corresponding to a face detected in the image to a specific folder (operation icon) displayed on the touch-sensitive display unit 120, a permission management function is automatically activated to grant permission for a specific user with the face. Similarly, in some embodiments, the detected face can be compared with a contact database to know the specific user and related information, such as personal ID of the specific user. The related information of the specific user can be automatically brought to the permission management function. In another embodiment, when a user draws a circle to cover two indicators corresponding to two faces detected in the image and drags the circle to an operation icon corresponding to an ad-hoc network connection function, an ad-hoc network connection function is automatically activated to set up an ad-hoc network with the two specific users with the faces. Similarly, the detected face can be compared with a contact database to know the specific user and related information, such as a network address of a mobile device of the specific user. The related information of the specific user can be automatically brought to the ad-hoc network connection function. In further another embodiment, when a user drags an indicator corresponding to a detected object, such as product, text, and others to a specific position or a specific folder displayed on the touch-sensitive display unit 120, a data retrieval function is automatically activated to link to a website, and perform a data retrieval process for the detected object. In an example, when a user drags an indicator of a product, such as a watch to a compare-price box (operation icon), a browser can be launch and linked to a price comparison service for results of the watch.

Therefore, the methods and systems for operation activation can automatically retrieve and perform at least one operation for at least one object which is recognized in an image displayed on the touch-sensitive display unit, thus increasing operational convenience, and reducing power consumption of electronic devices for complicated operations.

Methods for operation activation, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalent.

What is claimed is:

1. A method for operation activation, for use in an electronic device, comprising:
displaying an image on a touch-sensitive display unit;
recognizing at least one object in the image using an object recognition algorithm;
displaying at least one indicator for the at least one object on the touch-sensitive display unit;
retrieving at least one operation according to the at least one object;
receiving an instruction with respect to the at least one indicator via the touch-sensitive display unit; and
automatically performing the at least one operation regarding the at least one object according to the instruction.

2. The method of claim 1, wherein the at least one indicator is displayed as an icon besides or near the at least one object, or as an image covers part or all of the at least one object.

3. The method of claim 1, further comprising receiving a selection for at least one specific indicator within the at least one indicator, and the at least one operation is retrieved according to the selected at least one specific indicator.

4. The method of claim 1, further comprising retrieving the at least one operation according to the type or the number of the at least one object.

5. The method of claim 1, further comprising displaying the at least one operation on the touch-sensitive display unit.

6. The method of claim 5, wherein the instruction comprises contacts and movements involving the at least one indicator and a specific operation of the at least one operation on the touch-sensitive display unit.

7. The method of claim 1, wherein the instruction comprises double-clicking the at least one indicator on the touch-sensitive display unit, and the at least one operation comprises composing an email message for the object.

8. The method of claim 1, wherein the instruction comprises dragging the at least one indicator to a specific folder displayed on the touch-sensitive display unit, and the at least one operation comprises granting permission for the at least one object corresponding to the at least one indicator.

9. The method of claim 1, wherein the instruction comprises drawing a circle to cover the at least one indicator, and the at least one operation comprises setting up an ad-hoc network with the at least one object corresponding to the at least one indicator.

10. The method of claim 1, wherein the instruction comprises dragging the at least one indicator to a specific position or a specific folder displayed on the touch-sensitive display unit, and the at least one operation comprises linking to a website, and performing a data retrieval process for the at least one object corresponding to the at least one indicator.

11. A system for operation activation for use in an electronic device, comprising:
a storage unit comprising a plurality of operations for a plurality of objects;
a touch-sensitive display unit displaying an image; and
a processing unit recognizing at least one object in the image using an object recognition algorithm, displaying at least one indicator for the at least one object on the touch-sensitive display unit, retrieving at least one operation according to the at least one object, receiving an instruction with respect to the at least one indicator via the touch-sensitive display unit, and automatically performing the at least one operation regarding the at least one object according to the instruction.

12. The system of claim 11, wherein the at least one indicator is displayed as an icon besides or near the at least one object, or as an image covers part or all of the at least one object.

13. The system of claim 11, the processing unit further receives a selection for at least one specific indicator within the at least one indicator via the touch-sensitive display unit, and retrieves the at least one operation according to the selected at least one specific indicator.

14. The system of claim 11, wherein the processing unit further retrieves the at least one operation according to the type or the number of the at least one object.

15. The system of claim 11, wherein the processing unit further displays the at least one operation on the touch-sensitive display unit.

16. The system of claim 15, wherein the instruction comprises contacts and movements involving the at least one indicator and a specific operation of the at least one operation on the touch-sensitive display unit.

17. The system of claim 11, wherein the instruction comprises double-clicking the at least one indicator on the touch-sensitive display unit, and the at least one operation comprises composing an email message for the object.

18. The system of claim 11, wherein the instruction comprises dragging the at least one indicator to a specific folder displayed on the touch-sensitive display unit, and the at least one operation comprises granting permission for the at least one object corresponding to the at least one indicator.

19. The system of claim 11, wherein the instruction comprises drawing a circle to cover the at least one indicator, and the at least one operation comprises setting up an ad-hoc network with the at least one object corresponding to the at least one indicator.

20. The system of claim 11, wherein the instruction comprises dragging the at least one indicator to a specific position or a specific folder displayed on the touch-sensitive display unit, and the at least one operation comprises linking to a website, and performing a data retrieval process for the at least one object corresponding to the at least one indicator.

21. A machine-readable storage medium comprising a computer program, which, when executed, causes a device to perform a method for operation activation, wherein the method comprises:
displaying an image on a touch-sensitive display unit;
recognizing at least one object in the image using an object recognition algorithm;
displaying at least one indicator for the at least one object on the touch-sensitive display unit;
retrieving at least one operation according to the at least one object;
receiving an instruction with respect to the at least one indicator via the touch-sensitive display unit; and
automatically performing the at least one operation regarding the at least one object according to the instruction.
